(19) United States
(12) Patent Application Publication
(10) Pub. No.: US 2025/0342552 A1
(43) Pub. Date: Nov. 6, 2025

(54) METHOD AND APPARATUS FOR ANALYZING ANIMAL AND PLANT RESOURCES

(71) Applicant: Zhejiang Normal University, Jinhua (CN)

(72) Inventors: Libin Liu, Jinhua (CN); Qishuo Zeng, Jinhua (CN); Haojun Xia, Jinhua (CN); Liantong Jin, Jinhua (CN)

(21) Appl. No.: 18/936,966

(22) Filed: Nov. 4, 2024

(30) Foreign Application Priority Data
May 6, 2024 (CN) 202410551282.8

(51) Int. Cl. G06Q 99/00

(52) U.S. Cl. CPC G06Q 99/00

(57) ABSTRACT

The present disclosure relates to the technical field of resource analysis. Disclosed are a method and an apparatus for analyzing animal and plant resources, the method includes: acquiring information about animal and plant resources, and information about environmental climate in a first target range; and obtaining animal and plant association information of the first target range by analysis according to the information about animal and plant resources, in which the animal and plant association information is used to indicate association relationships among species in the first target range, and the species include animals and plants; calculating derivative biological information of the first target range according to the animal and plant association information and the information about environmental climate; and updating the information about animal and plant resources according to the derivative biological information.

### CROSS-REFERENCE TO RELATED APPLICATIONS

The present disclosure claims the priority of Chinese Patent Application No. 202410551282.8 filed on May 6, 2024 before CNIPA, which is hereby incorporated in its entirety by reference.

### TECHNICAL FIELD

The present disclosure relates to the technical field of resource analysis, and particularly relates to a method and an apparatus for analyzing animal and plant resources.

### BACKGROUND

With an improvement of productivity and an increase in the number of people, a living environment of human beings is changing, and more and more people are paying attention to a concept of harmonious coexistence between human beings and nature.

In order to keep a balanced living environment balanced human beings, reduce the impact of natural disasters on human beings, and improve the scientific nature of human protection of an ecological environment, it is particularly important to analyze v resources. In the prior art, analysis of the animal and plant resources is mostly conducted through manual surveys and analyses, which not only cause human disturbances to the environment but also make important data being omitted or lost due to a large volume of survey work, thereby resulting in inaccurate analysis of the animal and plant resources.

Therefore, it is particularly important to provide a technical solution to improve the accuracy of the animal and plant resource analysis.

### SUMMARY

Provided in the present disclosure is a method and device for analyzing animal and plant resources, which can improve the accuracy of animal and plant resource analysis.

In order to solve the above technical problems, in a first aspect of the present disclosure, disclosed is a method for analyzing animal and plant resources, including:
acquiring information about animal and plant resources, and information about environmental climate in a first target range;
obtaining animal and plant association information in the first target range by analysis according to the information about animal and plant resources, in which the animal and plant association information is used to indicate association relationships among species in the first target range, and the species include animals and plants;
calculating derivative biological information in the first target range according to the animal and plant association information and the information about environmental climate; and
updating the information about animal and plant resources according to the derivative biological information.

As an optional implementation, in the first aspect of the present disclosure, the information about animal and plant resources includes animal and plant resource distribution information and first environmental activity information, and the first environmental activity information is used to indicate historical environment activities in the first target range. The obtaining animal and plant association information in the first target range by analysis according to the information about animal and plant resources includes:
obtaining first association information, second association information and third association information in the first target range by analysis according to the animal and plant resource distribution information and the first environmental activity information, in which the first association information is used to indicate association relationships among the animals, the second association information is used to indicate association relationships among the plants, and the third association information is used to indicate association relationships between the animals and the plants; and
obtaining the animal and plant association information in the first target range by analysis according to the first association information, the second association information, and the third association information.

As an optional implementation, in the first aspect of the present disclosure, the first environmental activity information includes at least one type of environment sub-information including historical climate activity information, historical soil environment information, historical water resource environment information, historical gas distribution information, internal species activity information, and external species activity information. Each of the at least one type of environment sub-information is corresponding at a same historical moment, the internal species activity information is used to indicate historical activities of species in the first target range, the external species activity information is used to indicate first historical activities of alien species in a second target range outside the first target range, or second historical activities of alien species entering the first target range, or both the first historical activities of alien species in a second target range outside the first target range and the second historical activities of alien species entering the first target range, in which the alien species correspond to the species, the second target range is critical to the first target range and an environmental impact degree value of the second target range is greater than or equals to a preset environmental impact degree threshold, the environmental impact degree value is calculated according to the second environmental activity information in the second target range and the first environmental activity information, and the second environmental activity information corresponds to the first environmental activity information.

As an optional implementation, in the first aspect of the present disclosure, the obtaining first association information, second association information and third association information in the first target range by analysis according to the animal and plant resource distribution information and the first environmental activity information includes:
obtaining age structure information and food chain relationship information in the first target range by analysis according to the animal and plant resource distribution information and the first environmental activity information;
generating animal metabolite distribution information and plant metabolite distribution information in the first target range according to the age structure information, the food chain relationship information and the first environmental activity information, in which the animal metabolite distribution information includes at least one of hair distribution information, excrement distribution information, body fluid distribution information, first metabolic gas distribution information, first microorganism distribution information, and first tissue structure information, and the plant metabolite distribution information includes at least one of second metabolic gas distribution information, second microorganism distribution information, and second tissue structure information;
obtaining species metabolite association information in the first target range by analysis according to the animal metabolite distribution information and the plant metabolite distribution information;
obtaining gene distribution information and gene evolution information in the first target range by analysis according to the animal metabolite distribution information, the plant metabolite distribution information, and the species metabolite association information; and
obtaining the first association information, the second association information, and the third association information in the first target range by analysis according to the gene distribution information and the gene evolution information.

As an optional implementation, in the first aspect of the present disclosure, the information about environmental climate includes at least one type of climate sub-information including temperature information, humidity information, gas distribution information, water system distribution information, water system flow information, precipitation information, sunshine information, geological structure information, and mineral information, and each of the at least one type of climate sub-information is corresponding at the same historical moment. The calculating derivative biological information in the first target range according to the animal and plant association information and the information about environmental climate includes:
obtaining reproduction prediction information in the first target range by analysis according to the animal and plant association information and the age structure information.
calculating breeding environment information in the first target range according to the information about environmental climate and the first environmental activity information; and
calculating the derivative biological information in the first target range according to the reproduction prediction information and the breeding environment information.

As an optional implementation, in the first aspect of the present disclosure, the method further includes:
calculating an environmental comprehensive index of the first target range according to the updated information about animal and plant resources and a preset index generation model, in which the environmental comprehensive index includes at least one of a species health index, a species richness index, an overbreeding index, a land desertification index, and a pollution index; and
generating an optimized layout coefficient of the first target range according to the environmental comprehensive index, in which the optimized layout coefficient is used to adjust the environmental comprehensive index of the first target range.

As an optional implementation, in the first aspect of the present disclosure, the preset index generation model includes the linear regression model, and the calculating an environmental comprehensive index of the first target range according to the updated information about animal and plant resources and a preset index generation model includes:
calculating an environmental climate change variance coefficient of the first target range according to the updated information about animal and plant resources and the information about environmental climate;
calculating resource consumption changes and resource supply changes of the first target range according to the environmental climate change variance coefficient and the updated information about animal and plant resources; and
calculating the environmental comprehensive index of the first target range according to the preset index generation model and an input variable set, in which the input variable set includes the updated information about animal and plant resources, the environmental climate change variance coefficient, the resource consumption changes, and the resource supply changes.

In a second aspect of the present disclosure, disclosed is an apparatus for analyzing animal and plant resources, including:
an acquisition module, configured to acquire information about animal and plant resources, and information about environmental climate in a first target range;
an analysis module, configured to obtain animal and plant association information in the first target range by analysis according to the information about animal and plant resources, in which the animal and plant association information is used to indicate association relationships among species in the first target range, and the species include animals and plants;
a calculation module, configured to calculate derivative biological information in the first target range according to the animal and plant association information and the information about environmental climate; and
an update model, configured to update the information about animal and plant resources according to the derivative biological information.

As an optional implementation, in the second aspect of the present disclosure, the information about animal and plant resources includes animal and plant resource distribution information and first environmental activity information, and the first environmental activity information is used to indicate historical environment activities in the first target range. The an analysis model obtaining animal and plant association information in the first target range according to the information about animal and plant resources specifically includes:
analyzing first association information, second association information, and third association information in the first target range according to the animal and plant resource distribution information and the first environmental activity information, in which the first association information is used to indicate association relationships among the animals, the second association information is used to indicate association relationships among the plants, and the third association information is used to indicate association relationships between the animals and the plants; and
obtaining the animal and plant association information in the first target range by analysis according to the first association information, the second association information, and the third association information.

As an optional implementation, in the second aspect of the present disclosure, the first environmental activity information includes at least one type of environment sub-information including historical climate activity information, historical soil environment information, historical water resource environment information, historical gas distribution information, internal species activity information, and external species activity information. Each of the at least one type of environment sub-information environment sub-information is corresponding at a same historical moment. The internal species activity information is used to indicate historical activities of species in the first target range, the external species activity information is used to indicate first historical activities of alien species in a second target range outside the first target range or second historical activities of alien species entering the first target range, or both the first historical activities of alien species in a second target range outside the first target range and the second historical activities of alien species entering the first target range, in which the alien species correspond to the species, the second target range is critical to the first target range and an environmental impact degree value of the second target range is greater than or equals to a preset environmental impact degree threshold, the environmental impact degree value is calculated according to the second environmental activity information in the second target range and the first environmental activity information, and the second environmental activity information corresponds to the first environmental activity information.

As an optional implementation, in the second aspect of the present disclosure, the analysis model obtaining the first association information, the second association information and the third association information in the first target range by analysis according to the animal and plant resource distribution information and the first environmental activity information specifically includes:
obtaining age structure information and food chain relationship information in the first target range by analysis according to the animal and plant resource distribution information and the first environmental activity information;
generating animal metabolite distribution information and plant metabolite distribution information in the first target range according to the age structure information, the food chain relationship information and the first environmental activity information, in which the animal metabolite distribution information includes at least one of hair distribution information, excrement distribution information, body fluid distribution information, first metabolic gas distribution information, first microorganism distribution information, and first tissue structure information, and the plant metabolite distribution information includes at least one of second metabolic gas distribution information, second microorganism distribution information, and second tissue structure information;
obtaining species metabolite association information in the first target range by analysis according to the animal metabolite distribution information and the plant metabolite distribution information;
obtaining gene distribution information and gene evolution information in the first target range by analysis according to the animal metabolite distribution information, the plant metabolite distribution information, and the species metabolite association information; and
obtaining the first association information, the second association information, and the third association information in the first target range by analysis according to the gene distribution information and the gene evolution information.

As an optional implementation, in the second aspect of the present disclosure, the information about environmental climate includes at least one type of climate sub-information including temperature information, humidity information, gas distribution information, water system distribution information, water system flow information, precipitation information, sunshine information, geological structure information, and mineral information, and each of the at least one type of climate sub-information is corresponding at the same historical moment. The calculation module calculating derivative biological information in the first target range according to the animal and plant association information and the information about environmental climate specifically includes:
obtaining reproduction prediction information in the first target range by analysis according to the animal and plant association information and the age structure information.
calculating breeding environment information in the first target range according to the information about environmental climate and the first environmental activity information; and
calculating the derivative biological information in the first target range according to the reproduction prediction information and the breeding environment information.

As an optional implementation, in the second aspect of the present disclosure, the calculation model is further configured to calculate the environmental comprehensive index of the first target range according to the updated information about animal and plant resources and a preset index generation model, in which the environmental comprehensive index includes at least one of a species health index, a species richness index, an overbreeding index, a land desertification index, and a pollution index;

Further, the apparatus further includes:
a generation module, configured to generate an optimized layout coefficient of the first target range according to the environmental comprehensive index, in which the optimized layout coefficient is used to adjust the environmental comprehensive index of the first target range.

As an optional implementation, in the second aspect of the present disclosure, the preset index generation model includes the linear regression model, and the calculation module calculating the environmental comprehensive index of the first target range according to the updated information about animal and plant resources, and the preset index generation model specifically includes:
calculating an environmental climate change variance coefficient of the first target range according to the updated information about animal and plant resources and the information about environmental climate;
calculating resource consumption changes and resource supply changes of the first target range according to the environmental climate change variance coefficient and the updated information about animal and plant resources; and
calculating the environmental comprehensive index of the first target range according to the preset index generation model and an input variable set, in which the input variable set includes the updated information about animal and plant resources, the environmental climate change variance coefficient, the resource consumption changes, and the resource supply changes.

In a third aspect of the present disclosure, disclosed is another device for analyzing animal and plant resources, including:
a memory storing an executable program code; and
a processor coupled to the memory.

The processor invokes the executable program code stored in the memory to perform the method for analyzing animal and plant resources disclosed in the first aspect of the present disclosure.

In a fourth aspect of the present disclosure, disclosed is a non-transitory computer storage medium, in which the non-transitory computer storage medium stores computer instructions. The computer instructions, when invoked, are configured to cause the method for analyzing animal and plant resources disclosed in the first aspect of the present disclosure to be performed.

Compared with the prior art, the present disclosure has the following beneficial effects:

In the embodiments of the present disclosure, the information about animal and plant resources, and the information about environmental climate in the first range are acquired; the animal and plant association information in the first target range is obtained by analysis according to the information about animal and plant resources, the animal and plant association information is used to indicate association relationships among species in the first target range, and the species include animals and plants; the derivative biological information in the first target range is calculated according to the animal and plant association information and the information about environmental climate; and the information about animal and plant resources is updated according to the derivative biological information. It can be seen that, by implementing the present disclosure, the animal and plant association information in the first target range can be obtained by analysis according to the acquired animal and plant resource information in the first target range, the derivative biological information in the first target range can be calculated according to the association relationship among species in the first target range and the acquired environment climate information, and the animal and plant resource information can be updated according to the derivative biological information to improve the accuracy and update timeliness of the animal and plant resource analysis, which is conducive to improving the scientific nature of human protection of an ecological environment.

### BRIEF DESCRIPTION OF THE DRAWINGS

In order to more clearly illustrate the technical solution in the embodiments of the present disclosure, the accompanying drawings required to be used in the description of the embodiments are simply introduced below, and obviously, the accompanying drawings described below are only some embodiments of the present disclosure, such that for those of ordinary skill in the art, other drawings may further be derived from these drawings without making inventive efforts.

FIG. 1 is a schematic flowchart of a method for analyzing animal and plant resources disclosed in an embodiment of the present disclosure.

FIG. 2 is a schematic flowchart of another method for analyzing animal and plant resources disclosed in an embodiment of the present disclosure.

FIG. 3 is a schematic structural diagram of an apparatus for analyzing animal and plant resources disclosed in an embodiment of the present disclosure.

FIG. 4 is a schematic structural diagram of another apparatus for analyzing animal and plant resources disclosed in an embodiment of the present disclosure.

FIG. 5 is a schematic structural diagram of yet another apparatus for analyzing animal and plant resources disclosed in an embodiment of the present disclosure.

### DETAILED DESCRIPTION

In order to enable those skilled in the art to better understand the technical solutions of the present disclosure, the technical solutions of embodiments of the present disclosure will be described below clearly and comprehensively in conjunction with accompanying drawings of the embodiments of the present disclosure. Apparently, the embodiments described are merely some embodiments rather than all embodiments of the present disclosure. All the other embodiments acquired by those of ordinary skill in the art based on the embodiments in the present disclosure without creative efforts shall fall within the protection scope of the present disclosure.

The terms “first”, “second”, and the like, in the specification, claims, and accompanying drawings of the present disclosure are used to distinguish different objects rather than to describe a specific order. In addition, the terms “include/comprise” and “have/having” and any variations thereof are intended to cover non-exclusive inclusion. For example, a process, method, apparatus, product, or end that include a series of steps or units is not limited to the listed steps or units, but may optionally further include steps or units that are not listed, or optionally further include other steps or units inherent to these processes, methods, products, or ends.

Any reference to “embodiment” herein means that a particular feature, structure, or characteristic described in conjunction with an embodiment may be included in at least one embodiment of the present disclosure. Any phrase appearing in various places in the specification does not necessarily relate to the same embodiment, nor is an independent or alternative embodiment mutually exclusive with other embodiments. It is explicitly and implicitly understood by those skilled in the art that the embodiments described herein may be combined with other embodiments.

Disclosed in the present disclosure are a method and an apparatus for analyzing animal and plant resources, which can analyze animal and plant association information in a first target range according to the acquired animal and plant resource information in the first target range, calculate derivative biological information in the first target range according to the association relationship among species in the first target range and the acquired environment climate information, and update animal and plant resource information according to the derivative biological information to improve the accuracy and update timeliness of the animal and plant resource analysis, thereby facilitating improving the scientific nature of human protection of an ecological environment. Detailed description is given below.

### Embodiment 1

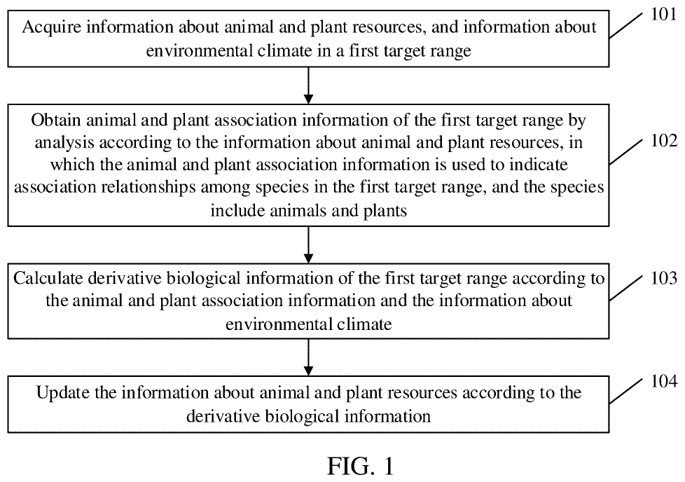

With reference to FIG. 1, FIG. 1 is a schematic flowchart of a method for analyzing animal and plant resources disclosed in an embodiment of the present disclosure. Specifically, the method for analyzing animal and plant resources described in FIG. 1 may be applied to a resource environment protection equipment, such as a detection sensor, and may also be applied to an intelligent equipment related to the detection sensor, and the intelligent equipment includes, but is not limited to, one or more of a battery device, a cloud device, an edge computing device, a relay device, a base station device, an urban management device, and an intelligent network connection device, which is not limited by the embodiments of the present disclosure. As shown in FIG. 1, the method for analyzing animal and plant resources may include the following steps:

In step 101, information about animal and plant resources, and information about environmental climate in a first target range are acquired.

In step 102, animal and plant association information of the first target range obtained by analysis according to the information about animal and plant resources, in which the animal and plant association information is used to indicate association relationships among species in the first target range, and the species include animals and plants.

In the embodiment of the present disclosure, as an optional implementation, the information about animal and plant resources includes animal and plant resource distribution information and first environmental activity information, and the first environmental activity information is used to indicate historical environment activities in the first target range. The animal and plant association information of the first target range being obtained by analysis according to the information about animal and plant resources may include the following steps:

First association information, second association information and third association information in the first target range are obtained by analysis according to the animal and plant resource distribution information and the first environmental activity information, in which the first association information is used to indicate association relationships among the animals, the second association information is used to indicate association relationships among the plants, and the third association information is used to indicate association relationships between the animals and the plants.

The animal and plant association information in the first target range is obtained by analysis according to the first association information, the second association information, and the third association information.

It can be seen that, by implementing the optional embodiment, the association relationships among animals, the association relationships among the plants, and the association relationships between the animals and the plants in the first target range can be obtained by analysis according to the animal and plant resource distribution information and the first environmental activity information, such that the animal and plant association information in the first target range can be further comprehensively integrated and the analysis accuracy of the animal and plant association information is improved, thereby facilitating further subsequent combination of the information about environmental climate, and improving the calculation accuracy of derivative biological information in the first target range.

In the embodiment of the present disclosure, as another optional implementation, the first environmental activity information described above includes at least one type of environment sub-information, such as historical climate activity information, historical soil environment information, historical water resource environment information, historical gas distribution information, internal species activity information, and external species activity information. Each of the at least one type of environment sub-information is corresponding at a same historical moment. The internal species activity information is used to indicate historical activities of species in the first target range. The external species activity information is used to indicate first historical activities of alien species in a second target range outside the first target range, or second historical activities of alien species entering the first target range, or both the first historical activities of alien species in the second target range outside the first target range and the second historical activities of alien species entering the first target range, in which the alien species correspond to the species, the second target range is critical to the first target range and an environmental impact degree value of the second target range is greater than or equals to a preset environmental impact degree threshold, the environmental impact degree value is calculated according to the second environmental activity information of the second target range and the first environmental activity information, and the second environmental activity information corresponds to the first environmental activity information.

In the optional embodiment, optionally, each of the at least one type of environment sub-information of the first environmental activity information and the corresponding second environmental activity information may have a corresponding first preset priority value, such that the environmental impact degree value may be calculated by using a linear regression model according to the second environmental activity information, the first environmental activity information, and the related first preset priority value.

It can be seen that, by implementing the optional embodiment, the analysis accuracy, scientific nature and operability of the animal and plant association information can be further improved by combining the first environmental activity information consisting of a plurality of types of environment sub-information with the animal and plant resource distribution information.

In the optional embodiment, as an optional implementation, the first association information, the second association information, and the third association information in the first target range being obtained by analysis according to the animal and plant resource distribution information and the first environmental activity information may include the following steps:

Age structure information and food chain relationship information in the first target range are obtained by analysis according to the animal and plant resource distribution information and the first environmental activity information.

Animal metabolite distribution information and plant metabolite distribution information in the first target range are generated according to the age structure information, the food chain relationship information, and the first environmental activity information, in which the animal metabolite distribution information includes at least one of hair distribution information, excrement distribution information, body fluid distribution information, first metabolic gas distribution information, first microorganism distribution information, and first tissue structure information, and the plant metabolite distribution information includes at least one of second metabolic gas distribution information, second microorganism distribution information, and second tissue structure information.

Species metabolite association information in the first target range is obtained by analysis according to the animal metabolite distribution information and the plant metabolite distribution information.

Gene distribution information and gene evolution information in the first target range are obtained by analysis according to the animal metabolite distribution information, the plant metabolite distribution information, and the species metabolite association information.

The first association information, the second association information, and the third association information in the first target range are obtained by analysis according to the gene distribution information and the gene evolution information.

It can be seen that, by implementing the optional embodiment, the age structure information and the food chain relationship information of the species in the first target range can be obtained by analysis according to the animal and plant resource distribution information and the first environmental activity information consisting of a plurality of types of environment sub-information, such that the animal metabolite distribution information and the plant metabolite distribution information in the first target range are generated by further combining the first environmental activity information. The species metabolite association information in the first target range may be further obtained by analysis due to the food chain relationship information in the first target range, which is conducive to further combining the animal metabolite distribution information and the plant metabolite distribution information to obtain the gene distribution information and gene evolution information in the first target range by analysis. Finally, the analysis accuracy of the association relationships among animals, the association relationships among the plants, and the association relationships between the animals and the plants in the first target range are improved through the gene analysis information and the gene evolution information, which is conducive to further improving the analysis accuracy, scientific nature and operability of the animal and plant association information.

In step 103, derivative biological information in the first target range is calculated according to the animal and plant association information and the information about environmental climate.

In the embodiment of the present disclosure, as another optional implementation, the information about environmental climate includes at least one type of climate sub-information, such as temperature information, humidity information, gas distribution information, water system distribution information, water system flow information, precipitation information, sunshine information, geological structure information, and mineral information, and each of the at least one type of climate sub-information is corresponding at the same historical moment. The derivative biological information in the first target range being calculated according to the animal and plant association information and the information about environmental climate may include the following steps:

Reproduction prediction information in the first target range is obtained by analysis according to the animal and plant association information and the age structure information.

Breeding environment information of the first target range is calculated according to the information about environmental climate and the first environmental activity information.

The derivative biological information in the first target range is calculated according to the reproduction prediction information and the breeding environment information.

In the optional embodiment, optionally, in each of the at least one type of climate sub-information described above, a second preset priority value of each of the at least one type of climate sub-information may be determined according to a historical climate environment of an actual application scenario. Further and optionally, when the breeding environment information of the first target range is calculated according to the environment climate information and the first environmental activity information, the second preset priority value of each of the at least one type of climate sub-information may be combined into a calculation process of the breeding environment information, and optionally may be specifically calculated in a linear regression manner.

It can be seen that, by implementing the optional embodiment, the reproduction prediction information of the first target range can be obtained by analysis according to the animal and plant association information and the age structure information, so as to predict reproduction situation of the current first target range without being affected by the climate and environmental activities. Further, the breeding environment information of the first target range is calculated in combination with the information about environmental climate consisting of a plurality of types of climate sub-information and the first environmental activity information, such that the derivative biological information in the first target range is then calculated according to the reproduction prediction information the prediction calculation accuracy, comprehensiveness and scientific nature of prediction calculation of derivative organisms are improved, which is conducive to improving the accuracy, timeliness and scientific nature of the animal and plant resource analysis.

In step 104, the information about animal and plant resources is updated according to the derivative biological information.

It can be seen that, by implementing the optional embodiment, the animal and plant association information in the first target range can be obtained by analysis according to the acquired animal and plant resource information in the first target range, the derivative biological information in the first target range can be calculated according to the association relationship among species in the first target range and the acquired environment climate information, and the animal and plant resource information can be updated according to the derivative biological information to improve the accuracy and update timeliness of the animal and plant resource analysis, which is conducive to improving the scientific nature of human protection of an ecological environment.

### Embodiment 2

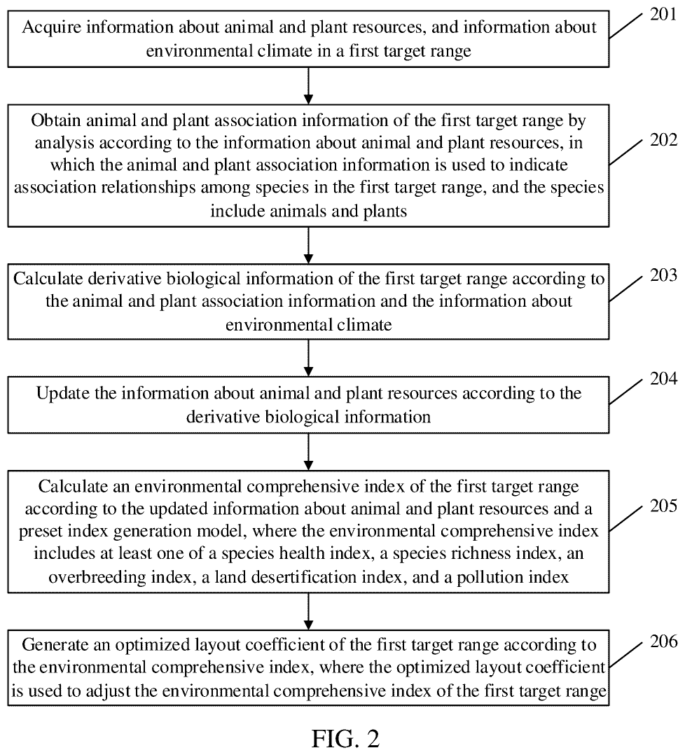

With reference to FIG. 2, FIG. 2 is a schematic flowchart of another method for analyzing animal and plant resources disclosed in an embodiment of the present disclosure. The method for analyzing animal and plant resources described in FIG. 2 may be applied to a resource environment protection equipment, such as a detection sensor, and may also be applied to an intelligent equipment related to the detection sensor, and the intelligent equipment includes, but is not limited to, one or more of a battery device, a cloud device, an edge computing device, a relay device, a base station device, an urban management device, and an intelligent network connection device, which is not limited by the embodiment of the present disclosure. As shown in FIG. 2, the method for analyzing animal and plant resources may include the following steps:

In step 201, information about animal and plant resources, and information about environmental climate in a first target range is acquired.

In step 202, animal and plant association information of the first target range is obtained by analysis according to the information about animal and plant resources, in which the animal and plant association information is used to indicate association relationships among species in the first target range, and the species include animals and plants.

In step 203, derivative biological information of the first target range is calculated according to the animal and plant association information and the information about environmental climate.

In step 204, the information about animal and plant resources is updated according to the derivative biological information.

In the embodiment of the present disclosure, refer to the supplementary description of Steps 101 to 104 in Embodiment 1 for the supplementary description of Steps 201 to 204, which will not be repeated in the embodiment.

In step 205, an environmental comprehensive index of the first target range is calculated according to the updated information about animal and plant resources and a preset index generation model, in which the environmental comprehensive index includes at least one of a species health index, a species richness index, an overbreeding index, a land desertification index, and a pollution index.

In the embodiment of the present disclosure, as an optional implementation, the preset index generation model includes the linear regression model. The environmental comprehensive index of the first target range being calculated according to the updated information about animal and plant resources and a preset index generation model” includes the following steps:

An environmental climate change variance coefficient of the first target range is calculated according to the updated information about animal and plant resources and the information about environmental climate.

Resource consumption changes and resource supply changes of the first target range are calculated according to the environmental climate change variance coefficient and the updated information about animal and plant resources.

The environmental comprehensive index of the first target range is calculated according to the preset index generation model and an input variable set, in which the input variable set includes the updated information about animal and plant resources, the environmental climate change variance coefficient, the resource consumption changes, and the resource supply changes.

In the optional embodiment, optionally, the environmental climate change variance coefficient may be calculated according to the updated information about animal and plant resources and the information about environmental climate at various historical moments in combination with a variance calculation formula.

In the optional embodiment, optionally, the preset index generation model may further include at least one generation sub-model, such as a preset point cloud generation model, a preset spectrum generation model, a preset image generation model, and a preset data conversion model. The at least one generation sub-model is configured to generate at least one of point cloud data, spectral data, image data, and the like according to the updated information about animal and plant resources, correspondingly, and then generate the environmental comprehensive index according to at least one of the generated point cloud data, spectral data, image data, and the like, so as to improve the model understanding of the updated information about animal and plant resources, improve the depth of understanding of comprehensive analysis of the animal and plant resources, and further to improve the generation accuracy of the environment comprehensive index.

It can be seen that, by implementing the optional embodiment, the environmental climate change variance coefficient of the first target range can be calculated according to the updated information about animal and plant resources and the information about environmental climate, such that the resource consumption changes and the resource supply changes of the first target range can be further calculated in combination with the updated information about animal and plant resources, and the environmental comprehensive index of the first target range can be further calculated in the linear regression mode, so as to improve the accuracy of further animal and plant resource analysis for the first target range as well as the accuracy and scientific nature of regulating protection.

In step 206, an optimized layout coefficient of the first target range is generated according to the environmental comprehensive index, in which the optimized layout coefficient is used to adjust the environmental comprehensive index of the first target range.

It can be seen that, by implementing the optional embodiment, the animal and plant association information in the first target range can be obtained by analysis according to the acquired animal and plant resource information in the first target range, the derivative biological information in the first target range can be calculated according to the association relationship among species in the first target range and the acquired environment climate information, and the animal and plant resource information can be updated according to the derivative biological information to improve the accuracy and update timeliness of animal and plant resource analysis, which is conducive to improving the scientific nature of human protection of an ecological environment, and the environmental comprehensive index of the first target range can be further calculated to generate the optimized layout coefficient of the first target range in combination with the environmental climate information and the preset index generation model, so as to further improve the accuracy of further animal and plant resource analysis for the first target range as well as the accuracy and scientific nature of regulating protection.

### Embodiment 3

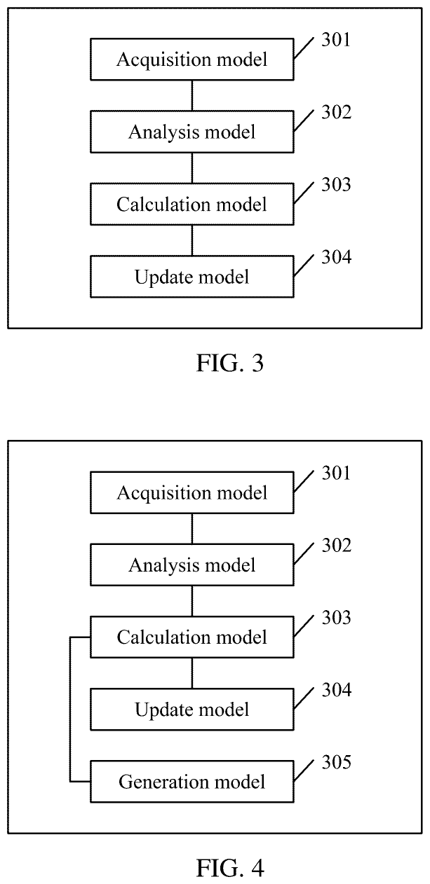

With reference to FIG. 3, FIG. 3 is a schematic structural diagram of an apparatus for analyzing animal and plant resources disclosed in an embodiment of the present disclosure. The apparatus for analyzing animal and plant resources may be applied to a resource environment protection equipment, such as a detection sensor, and may also be applied to an intelligent equipment related to the detection sensor, and the intelligent equipment includes, but is not limited to, one or more of a battery device, a cloud device, an edge computing device, a relay device, a base station device, an urban management device, and an intelligent network connection device, which is not limited by the embodiments of the present disclosure. As shown in FIG. 3, the apparatus for analyzing animal and plant resources may include:
an acquisition module 301, configured to acquire information about animal and plant resources, and information about environmental climate in a first target range;
an analysis module 302, configured to obtain animal and plant association information of the first target range by analysis according to the information about animal and plant resources, in which the animal and plant association information is used to indicate association relationships among species in the first target range, and the species include animals and plants;
a calculation module 303, configured to calculate derivative biological information of the first target range according to the animal and plant association information and the information about environmental climate; and
an update module 304, configured to update the information about animal and plant resources according to the derivative biological information.

It can be seen that, by implementing the optional embodiment, the animal and plant association information in the first target range can be obtained by analysis according to the acquired animal and plant resource information in the first target range, the derivative biological information in the first target range can be calculated according to the association relationship among species in the first target range and the acquired environment climate information, and the animal and plant resource information can be updated according to the derivative biological information to improve the accuracy and update timeliness of animal and plant resource analysis, which is conducive to improving the scientific nature of human protection of an ecological environment.

In the embodiment of the present disclosure, as an optional implementation, the information about animal and plant resources includes animal and plant resource distribution information and first environmental activity information, and the first environmental activity information is used to indicate historical environment activities in the first target range. The above analysis module 302 obtaining the animal and plant association information of the first target range by analysis according to the information about animal and plant resources includes the following specific operations:

First association information, second association information and third association information of the first target range are obtained by analysis according to the animal and plant resource distribution information and the first environmental activity information, in which the first association information is used to indicate association relationships among the animals, the second association information is used to indicate association relationships among the plants, and the third association information is used to indicate association relationships among the animals and the plants.

The animal and plant association information of the first target range is obtained by analysis according to the first association information, the second association information, and the third association information.

It can be seen that, by implementing the optional embodiment, the association relationships among animals, the association relationships among the plants, and the association relationships between the animals and the plants in the first target range can be obtained by analysis according to the animal and plant resource distribution information and the first environmental activity information, such that the animal and plant association information of the first target range can be further comprehensively integrated and the analysis accuracy of the animal and plant association information is improved, thereby facilitating further subsequent combination of the information about environmental climate, and improving the calculation accuracy of the derivative biological information of the first target range.

In the embodiment of the present disclosure, as another optional implementation, the first environmental activity information includes at least one type of environment sub-information, such as historical climate activity information, historical soil environment information, historical water resource environment information, historical gas distribution information, internal species activity information, and external species activity information. Each of the at least one type environment sub-information is corresponding at a same historical moment, the internal species activity information is used to indicate historical activities of species in the first target range, the external species activity information is used to indicate first historical activities of alien species in a second target range outside the first target range, or second historical activities of alien species entering the first target range, or both the first historical activities of alien species in a second target range outside the first target range and the second historical activities of alien species entering the first target range, in which the alien species correspond to the species, the second target range is critical to the first target range and an environmental impact degree value of the second target range is greater than or equals to a preset environmental impact degree threshold, the environmental impact degree value is calculated according to the second environmental activity information of the second target range and the first environmental activity information, and the second environmental activity information corresponds to the first environmental activity information.

It can be seen that, by implementing the optional embodiment, the analysis accuracy, scientific nature and operability of the animal and plant association information can be further improved by combining the first environmental activity information of a plurality of environment sub-information with the animal and plant resource distribution information.

In the optional embodiment, as an optional implementation, the analysis module 302 obtaining the first association information, the second association information and the third association information of the first target range by analysis according to the animal and plant resource distribution information and the first environmental activity information includes the following specific operations:

Age structure information and food chain relationship information of the first target range are obtained by analysis according to the animal and plant resource distribution information and the first environmental activity information.

Animal metabolite distribution information and plant metabolite distribution information of the first target range are generated according to the age structure information, the food chain relationship information and the first environmental activity information, in which the animal metabolite distribution information includes at least one of hair distribution information, excrement distribution information, body fluid distribution information, first metabolic gas distribution information, first microorganism distribution information, and first tissue structure information, and the plant metabolite distribution information includes at least one of second metabolic gas distribution information, second microorganism distribution information, and second tissue structure information.

Species metabolite association information of the first target range is obtained by analysis according to the animal metabolite distribution information and the plant metabolite distribution information.

Gene distribution information and gene evolution information of the first target range are obtained by analysis according to the animal metabolite distribution information, the plant metabolite distribution information, and the species metabolite association information.

The first association information, the second association information, and the third association information of the first target range are obtained by analysis according to the gene distribution information and the gene evolution information.

It can be seen that, by implementing the optional embodiment, the age structure information and the food chain relationship information of the species in the first target range can be obtained by analysis according to the animal and plant resource distribution information, and the first environmental activity information composed of the plurality of environment sub-information, such that the animal metabolite distribution information and the plant metabolite distribution information of the first target range are generated by further combining the first environmental activity information; the species metabolite association information of the first target range can be further obtained by analysis according to the food chain relationship information of the first target range, which is conducive to further combining the animal metabolite distribution information and the plant metabolite distribution information, and so as to obtain the gene distribution information and gene evolution information of the first target range by analysis. Finally, the analysis accuracy of the association relationships among animals, the association relationships among the plants, and the association relationships between the animals and the plants in the first target range are improved through the gene analysis information and the gene evolution information, which is conducive to further improving the analysis accuracy, scientific nature and operability of the animal and plant association information.

In the embodiment of the present disclosure, as another optional implementation, the information about environmental climate includes at least one type of climate sub-information, such as temperature information, humidity information, gas distribution information, water system distribution information, water system flow information, precipitation information, sunshine information, geological structure information, and mineral information. Each of the at least one type of climate sub-information is corresponding at the same historical moment. The calculation module 303 calculating the derivative biological information of the first target range according to the animal and plant association information and the information about environmental climate includes the following specific operations:

Reproduction prediction information of the first target range is obtained by analysis according to the animal and plant association information and the age structure information.

Breeding environment information of the first target range is calculated according to the information about environmental climate and the first environmental activity information.

The derivative biological information in the first target range is calculated according to the reproduction prediction information and the breeding environment information.

It can be seen that, by implementing the optional embodiment, the reproduction prediction information of the first target range can be obtained by analysis according to the animal and plant association information and the age structure information, so as to predict reproduction situation of the current first target range without being affected by the climate and environmental activities. Further, the breeding environment information of the first target range is calculated in combination with the information about environmental climate consisting of a plurality of climate sub-information and the first environmental activity information, such that the derivative biological information in the first target range is then calculated according to the reproduction prediction information the prediction calculation accuracy, comprehensiveness and scientific nature of prediction calculation of derivative organisms are improved, which is conducive to improving the accuracy, timeliness and scientific nature of the animal and plant resource analysis.

In an optional embodiment, the calculation module 303 is further configured to calculate the environmental comprehensive index of the first target range according to the updated information about animal and plant resources and a preset index generation model, in which the environmental comprehensive index includes at least one of a species health index, a species richness index, an overbreeding index, a land desertification index, and a pollution index.

Further, as shown in FIG. 4, the apparatus may further include:
a generation module 305, configured to generate an optimized layout coefficient of the first target range according to the environmental comprehensive index, in which the optimized layout coefficient is used to adjust the environmental comprehensive index of the first target range.

It can be seen that, by implementing the optional embodiment, the animal and plant association information in the first target range can be obtained by analysis according to the acquired animal and plant resource information in the first target range, the derivative biological information in the first target range can be calculated according to the association relationship among species in the first target range and the acquired environment climate information, and the animal and plant resource information can be updated according to the derivative biological information to improve the accuracy and update timeliness of animal and plant resource analysis, which is conducive to improving the scientific nature of human protection of an ecological environment, and the environmental comprehensive index of the first target range can be further calculated to generate the optimized layout coefficient of the first target range in combination with the environmental climate information and the preset index generation model, so as to further improve the accuracy of further animal and plant resource analysis for the first target range as well as the accuracy and scientific nature in regulating protection.

In the optional embodiment, as an optional implementation, the preset index generation model includes the linear regression model, and the calculation module 303 calculating an environmental comprehensive index of the first target range according to the updated information about animal and plant resources and a preset index generation model includes the following operations:

An environmental climate change variance coefficient of the first target range is calculated according to the updated information about animal and plant resources and the information about environmental climate.

Resource consumption changes and resource supply changes of the first target range are calculated according to the environmental climate change variance coefficient and the updated information about animal and plant resources.

The environmental comprehensive index of the first target range is calculated according to the preset index generation model and an input variable set, in which the input variable set includes the updated information about animal and plant resources, the environmental climate change variance coefficient, the resource consumption changes, and the resource supply changes.

It can be seen that, by implementing the optional embodiment, the environmental climate change variance coefficient of the first target range can be calculated according to the updated information about animal and plant resources and the information about environmental climate, such that the resource consumption changes and the resource supply changes of the first target range can be further calculated in combination with the updated information about animal and plant resources, the environmental comprehensive index of the first target range can be further calculated in the linear regression mode, so as to improve the accuracy of further animal and plant resource analysis for the first target range as well as the accuracy and scientific nature in regulating protection.

### Embodiment 4

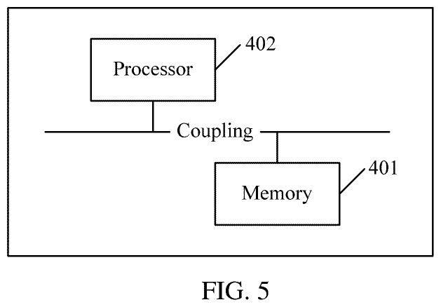

With reference to FIG. 5, FIG. 5 is a schematic structural diagram of another apparatus for analyzing animal and plant resources disclosed in an embodiment of the present disclosure. The apparatus for analyzing animal and plant resources may be applied to a resource environment protection equipment, such as a detection sensor, and may also be applied to an intelligent equipment related to the detection sensor, and the intelligent equipment includes, but is not limited to, one or more of a battery device, a cloud device, an edge computing device, a relay device, a base station device, an urban management device, and an intelligent network connection device, which is not limited by the embodiments of the present disclosure. As shown in FIG. 5, the apparatus for analyzing animal and plant resources may include:
a memory 401 storing an executable program code; and
a processor 402 coupled to the memory 401.

The processor 402 invokes the executable program code stored in the memory 401 to perform the steps of the method for analyzing animal and plant resources disclosed in Embodiment 1 or 2 of the present disclosure.

### Embodiment 5

Disclosed in the embodiment of the present disclosure is a non-transitory computer storage medium. The non-transitory computer storage medium stores computer instructions. When the computer instructions are invoked, the computer instructions are configured to cause the steps of the method for analyzing animal and plant resources disclosed in Embodiment 1 or 2 of the present disclosure to be performed.

### Embodiment 6

Disclosed in the embodiment of the present disclosure is a computer program product, which includes a non-transitory computer storage medium storing a computer program, and the computer program is operable to enable a computer to perform the steps of the method for analyzing animal and plant resources disclosed in Embodiment 1 or 2 of the present disclosure.

The apparatus embodiments described above are merely schematic, in which the modules described as separate components may or may not be physically separated, and a component displayed as a module may or may not be a physical unit, that is, the component may be located at one place, or distributed on a plurality of network modules. Part or all of the modules may be selected according to actual requirements to achieve the objective of the solution of the embodiments. Those of ordinarily skilled in the art may understand and implement the present disclosure without making the inventive effort.

From the description of the above embodiments, it may be apparent to those skilled in the art that each implementation may be achieved by means of software plus a general-purpose hardware platform, and certainly may also be achieved by means of hardware. Based on the understanding, the above technical solutions, in essence or in other words, contributing to the prior art can be embodied in the form of a software product, and the computer software product can be stored in a computer-readable storage medium, and the storage medium includes a Read-Only Memory (ROM), a Random Access Memory (RAM), a Programmable Read-only Memory (PROM), an Erasable Programmable Read Only Memory (EPROM), a One-time Programmable Read-Only Memory (OTPROM), an Electrically-Erasable Programmable Read-Only Memory (EEPROM), a Compact Disc Read-Only Memory (CD-ROM) or other optical disk memories, a magnetic disk memory, a magnetic tape memory, or any other medium capable of carrying or storing data.

Finally, it should be noted that the method and apparatus for analyzing animal and plant resources disclosed in the embodiments of the present disclosure are merely preferred embodiments of the present disclosure and are merely intended to illustrate the technical solution of the present disclosure, but not to limit the same; although the present disclosure has been described in detail with reference to the foregoing embodiments, it should be understood by those of ordinary skill in the art that the technical solutions described in the foregoing embodiments may be modified or equivalents may be substituted for some of the technical features thereof; and the modification or substitution does not make the essence of the corresponding technical solution deviate from the spirit and scope of the technical solution of each embodiment of the present disclosure.

1. A method for analyzing animal and plant resources, comprising:
acquiring information about animal and plant resources, and information about environmental climate in a first target range;
obtaining animal and plant association information of the first target range by analysis according to the information about animal and plant resources, wherein the animal and plant association information is used to indicate association relationships among species in the first target range, and the species comprise animals and plants;
calculating derivative biological information of the first target range according to the animal and plant association information and the information about environmental climate; and
updating the information about animal and plant resources according to the derivative biological information.

2. The method for analyzing animal and plant resources according to claim 1, wherein the information about animal and plant resources comprises animal and plant resource distribution information and first environmental activity information, the first environmental activity information is used to indicate historical environment activities in the first target range, and the obtaining animal and plant association information of the first target range by analysis according to the information about animal and plant resources comprises:
obtaining first association information, second association information and third association information of the first target range by analysis according to the animal and plant resource distribution information and the first environmental activity information, wherein the first association information is used to indicate association relationships among the animals, the second association information is used to indicate association relationships among the plants, and the third association information is used to indicate association relationships between the animals and the plants; and
obtaining the animal and plant association information in the first target range by analysis according to the first association information, the second association information, and the third association information.

3. The method for analyzing animal and plant resources according to claim 2, wherein the first environmental activity information comprises at least one type of environment sub-information including historical climate activity information, historical soil environment information, historical water resource environment information, historical gas distribution information, internal species activity information, and external species activity information, each of the at least one type of environment sub-information is corresponding at a same historical moment, and the internal species activity information is used to indicate historical activities of species in the first target range, and the external species activity information is used to indicate first historical activities of alien species in a second target range outside the first target range, or second historical activities of alien species entering the first target range, or both the first historical activities of alien species in a second target range outside the first target range and the second historical activities of alien species entering the first target range,
wherein the alien species correspond to the species, the second target range is critical to the first target range and an environmental impact degree value of the second target range is greater than or equals to a preset environmental impact degree threshold, the environmental impact degree value is calculated according to the second environmental activity information in the second target range and the first environmental activity information, and the second environmental activity information corresponds to the first environmental activity information.

4. The method for analyzing animal and plant resources according to claim 3, wherein the obtaining first association information, second association information and third association information in the first target range by analysis according to the animal and plant resource distribution information and the first environmental activity information comprises:
obtaining age structure information and food chain relationship information in the first target range by analysis according to the animal and plant resource distribution information and the first environmental activity information;
generating animal metabolite distribution information and plant metabolite distribution information in the first target range according to the age structure information, the food chain relationship information and the first environmental activity information, wherein the animal metabolite distribution information comprises at least one of hair distribution information, excrement distribution information, body fluid distribution information, first metabolic gas distribution information, first microorganism distribution information, and first tissue structure information, and the plant metabolite distribution information comprises at least one of second metabolic gas distribution information, second microorganism distribution information, and second tissue structure information;
obtaining species metabolite association information in the first target range by analysis according to the animal metabolite distribution information and the plant metabolite distribution information;
obtaining gene distribution information and gene evolution information in the first target range by analysis according to the animal metabolite distribution information, the plant metabolite distribution information, and the species metabolite association information; and
obtaining the first association information, the second association information, and the third association information in the first target range by analysis according to the gene distribution information and the gene evolution information.

5. The method for analyzing animal and plant resources according to claim 4, wherein the information about environmental climate comprises at least one type of climate sub-information including temperature information, humidity information, gas distribution information, water system distribution information, water system flow information, precipitation information, sunshine information, geological structure information, and mineral information, each of at the least one type of climate sub-information is corresponding to the same historical moment, and the calculating derivative biological information in the first target range according to the animal and plant association information and the information about environmental climate comprises:
obtaining reproduction prediction information in the first target range by analysis according to the animal and plant association information and the age structure information;
calculating breeding environment information in the first target range according to the information about environmental climate and the first environmental activity information; and
calculating the derivative biological information in the first target range according to the reproduction prediction information and the breeding environment information.

6. The method for analyzing animal and plant resources according to claim 1, further comprising:
calculating an environmental comprehensive index of the first target range according to the updated information about animal and plant resources and a preset index generation model, wherein the environmental comprehensive index comprises at least one of a species health index, a species richness index, an overbreeding index, a land desertification index, and a pollution index; and
generating an optimized layout coefficient of the first target range according to the environmental comprehensive index, wherein the optimized layout coefficient is used to adjust the environmental comprehensive index of the first target range.

7. The method for analyzing animal and plant resources according to claim 2, further comprising:
calculating an environmental comprehensive index of the first target range according to the updated information about animal and plant resources and a preset index generation model, wherein the environmental comprehensive index comprises at least one of a species health index, a species richness index, an overbreeding index, a land desertification index, and a pollution index; and
generating an optimized layout coefficient of the first target range according to the environmental comprehensive index, wherein the optimized layout coefficient is used to adjust the environmental comprehensive index of the first target range.

8. The method for analyzing animal and plant resources according to claim 3, further comprising:
calculating an environmental comprehensive index of the first target range according to the updated information about animal and plant resources and a preset index generation model, wherein the environmental comprehensive index comprises at least one of a species health index, a species richness index, an overbreeding index, a land desertification index, and a pollution index; and
generating an optimized layout coefficient of the first target range according to the environmental comprehensive index, wherein the optimized layout coefficient is used to adjust the environmental comprehensive index of the first target range.

9. The method for analyzing animal and plant resources according to claim 4, further comprising:
calculating an environmental comprehensive index of the first target range according to the updated information about animal and plant resources and a preset index generation model, wherein the environmental comprehensive index comprises at least one of a species health index, a species richness index, an overbreeding index, a land desertification index, and a pollution index; and
generating an optimized layout coefficient of the first target range according to the environmental comprehensive index, wherein the optimized layout coefficient is used to adjust the environmental comprehensive index of the first target range.

10. The method for analyzing animal and plant resources according to claim 5, further comprising:
calculating an environmental comprehensive index of the first target range according to the updated information about animal and plant resources and a preset index generation model, wherein the environmental comprehensive index comprises at least one of a species health index, a species richness index, an overbreeding index, a land desertification index, and a pollution index; and
generating an optimized layout coefficient of the first target range according to the environmental comprehensive index, wherein the optimized layout coefficient is used to adjust the environmental comprehensive index of the first target range.

11. The method for analyzing animal and plant resources according to claim 6, wherein the preset index generation model comprises a linear regression model, and the calculating an environmental comprehensive index of the first target range according to the updated information about animal and plant resources and a preset index generation model comprises:
calculating an environmental climate change variance coefficient of the first target range according to the updated information about animal and plant resources and the information about environmental climate;
calculating resource consumption changes and resource supply changes of the first target range according to the environmental climate change variance coefficient and the updated information about animal and plant resources; and
calculating the environmental comprehensive index of the first target range according to the preset index generation model and an input variable set, wherein the input variable set comprises the updated information about animal and plant resources, the environmental climate change variance coefficient, the resource consumption changes, and the resource supply changes.

12. A apparatus e for analyzing animal and plant resources, comprising:
a memory, storing an executable program code; and
a processor, coupled to the memory,
wherein the processor invokes the executable program code stored in the memory to perform a method for analyzing animal and plant resources, and the method comprises:
acquiring information about animal and plant resources, and information about environmental climate in a first target range;
obtaining animal and plant association information of the first target range by analysis according to the information about animal and plant resources, wherein the animal and plant association information is used to indicate association relationships among species in the first target range, and the species comprise animals and plants;
calculating derivative biological information of the first target range according to the animal and plant association information and the information about environmental climate; and
updating the information about animal and plant resources according to the derivative biological information.

13. The apparatus for analyzing animal and plant resources according to claim 12, wherein the information about animal and plant resources comprises animal and plant resource distribution information and first environmental activity information, the first environmental activity information is used to indicate historical environment activities in the first target range, and the obtaining animal and plant association information of the first target range by analysis according to the information about animal and plant resources comprises:
obtaining first association information, second association information and third association information of the first target range by analysis according to the animal and plant resource distribution information and the first environmental activity information, wherein the first association information is used to indicate association relationships among the animals, the second association information is used to indicate association relationships among the plants, and the third association information is used to indicate association relationships between the animals and the plants; and
obtaining the animal and plant association information in the first target range by analysis according to the first association information, the second association information, and the third association information.

14. The apparatus for analyzing animal and plant resources according to claim 13, wherein the first environmental activity information comprises at least one type of environment sub-information including historical climate activity information, historical soil environment information, historical water resource environment information, historical gas distribution information, internal species activity information, and external species activity information, each of the at least one type of environment sub-information is corresponding at a same historical moment, and the internal species activity information is used to indicate historical activities of species in the first target range, and the external species activity information is used to indicate first historical activities of alien species in a second target range outside the first target range, or second historical activities of alien species entering the first target range, or both the first historical activities of alien species in a second target range outside the first target range and the second historical activities of alien species entering the first target range,
wherein the alien species correspond to the species, the second target range is critical to the first target range and an environmental impact degree value of the second target range is greater than or equal to a preset environmental impact degree threshold, the environmental impact degree value is calculated according to the second environmental activity information in the second target range and the first environmental activity information, and the second environmental activity information corresponds to the first environmental activity information.

15. The apparatus for analyzing animal and plant resources according to claim 14, wherein the obtaining first association information, second association information and third association information in the first target range by analysis according to the animal and plant resource distribution information and the first environmental activity information comprises:
obtaining age structure information and food chain relationship information in the first target range by analysis according to the animal and plant resource distribution information and the first environmental activity information;
generating animal metabolite distribution information and plant metabolite distribution information in the first target range according to the age structure information, the food chain relationship information and the first environmental activity information, wherein the animal metabolite distribution information comprises at least one of hair distribution information, excrement distribution information, body fluid distribution information, first metabolic gas distribution information, first microorganism distribution information, and first tissue structure information, and the plant metabolite distribution information comprises at least one of second metabolic gas distribution information, second microorganism distribution information, and second tissue structure information;
obtaining species metabolite association information in the first target range by analysis according to the animal metabolite distribution information and the plant metabolite distribution information;
obtaining gene distribution information and gene evolution information in the first target range by analysis according to the animal metabolite distribution information, the plant metabolite distribution information, and the species metabolite association information; and
obtaining the first association information, the second association information, and the third association information in the first target range by analysis according to the gene distribution information and the gene evolution information.

16. The apparatus for analyzing animal and plant resources according to claim 15, wherein the information about environmental climate comprises at least one type of climate sub-information including temperature information, humidity information, gas distribution information, water system distribution information, water system flow information, precipitation information, sunshine information, geological structure information, and mineral information, each of at the least one type of climate sub-information is corresponding to the same historical moment, and the calculating derivative biological information in the first target range according to the animal and plant association information and the information about environmental climate comprises:
obtaining reproduction prediction information in the first target range by analysis according to the animal and plant association information and the age structure information;
calculating breeding environment information in the first target range according to the information about environmental climate and the first environmental activity information; and
calculating the derivative biological information in the first target range according to the reproduction prediction information and the breeding environment information.

17. The apparatus for analyzing animal and plant resources according to claim 12, further comprising:
calculating an environmental comprehensive index of the first target range according to the updated information about animal and plant resources and a preset index generation model, wherein the environmental comprehensive index comprises at least one of a species health index, a species richness index, an overbreeding index, a land desertification index, and a pollution index; and
generating an optimized layout coefficient of the first target range according to the environmental comprehensive index, wherein the optimized layout coefficient is used to adjust the environmental comprehensive index of the first target range.

18. The apparatus for analyzing animal and plant resources according to claim 17, wherein the preset index generation model comprises a linear regression model, and the calculating an environmental comprehensive index of the first target range according to the updated information about animal and plant resources and a preset index generation model comprises:
calculating an environmental climate change variance coefficient of the first target range according to the updated information about animal and plant resources and the information about environmental climate;
calculating resource consumption changes and resource supply changes of the first target range according to the environmental climate change variance coefficient and the updated information about animal and plant resources; and
calculating the environmental comprehensive index of the first target range according to the preset index generation model and an input variable set, wherein the input variable set comprises the updated information about animal and plant resources, the environmental climate change variance coefficient, the resource consumption changes, and the resource supply changes.

19. A non-transitory computer storage medium, wherein the non-transitory computer storage medium stores computer instructions, the computer instructions, when invoked, are configured to cause a method for analyzing animal and plant resources to be performed, and the method comprises:
acquiring information about animal and plant resources, and information about environmental climate in a first target range;
obtaining animal and plant association information of the first target range by analysis according to the information about animal and plant resources, wherein the animal and plant association information is used to indicate association relationships among species in the first target range, and the species comprise animals and plants;
calculating derivative biological information of the first target range according to the animal and plant association information and the information about environmental climate; and
updating the information about animal and plant resources according to the derivative biological information.

20. The non-transitory computer storage medium according to claim 19, wherein the information about animal and plant resources comprises animal and plant resource distribution information and first environmental activity information, the first environmental activity information is used to indicate historical environment activities in the first target range, and the obtaining animal and plant association information of the first target range by analysis according to the information about animal and plant resources comprises:
obtaining first association information, second association information and third association information of the first target range by analysis according to the animal and plant resource distribution information and the first environmental activity information, wherein the first association information is used to indicate association relationships among the animals, the second association information is used to indicate association relationships among the plants, and the third association information is used to indicate association relationships between the animals and the plants; and
obtaining the animal and plant association information in the first target range by analysis according to the first association information, the second association information, and the third association information.
